(19) United States
(12) Patent Application Publication
(10) Pub. No.: US 2006/0190845 A1
(43) Pub. Date: Aug. 24, 2006

(54) Portable storage devices

(75) Inventor: Chia-Ching Lu, Kaohsiung County (TW)

Correspondence Address: BIRCH STEWART KOLASCH & BIRCH, PO BOX 747, FALLS CHURCH, VA, 22040-0747, US

(73) Assignee: Winbond Electronics Corp.

(21) Appl. No.: 11/053,861

(22) Filed: Feb. 10, 2005

(51) Int. Cl. G06F 17/00

(52) U.S. Cl. 715/866

(57) ABSTRACT

A portable storage device comprises a nonvolatile memory, a nonvolatile memory area, an indicator, and a controller. When machine-readable data stored in the nonvolatile memory is altered, the controller automatically calculates utilization information of the nonvolatile memory and stores the same in the nonvolatile memory area. The indicator is coupled to the nonvolatile memory, nonvolatile memory area, and the controller and displays the utilization information accordingly.

### BACKGROUND

The invention relates to computer techniques, and in particular, to portable storage devices.

Typically, an operating system (OS) or an embedded program is required to compute utilization information (such as free space or used space) of storage devices, such as hard disks, PC Memory Card International Association (PCMCIA) cards, Compact Flash (CF) cards, SmartMedia (SM) cards, Memory Sticks, Secure Digital (SD) cards, MultiMediaCard (MMC), xD-Picture Cards, and IBM Microdrives. If utilization information of a plurality of existing storage devices is required, they must respectively connect to computing devices (such as personal computers, digital cameras, Personal Digital Assistant (PDA), and music players to present utilization information thereof, which is time intensive.

### SUMMARY

Accordingly, portable storage devices are provided. An exemplary embodiment of a portable storage device comprises a non-volatile memory, a non-volatile memory area, a controller, and an indicator. The memory stores machine-readable data. When data stored therein changes, the controller automatically calculates utilization information of the memory and stores the utilization information in the memory area. The indicator displays the utilization information stored in the memory area.

An exemplary embodiment of the portable storage device comprises a non-volatile memory, a controller, and an indicator. The memory stores machine-readable data. When data stored therein changes, the controller automatically calculates utilization information of the memory. The indicator automatically displays the utilization information. The controller calculates last utilization information of the memory while the portable storage device is provided with power. The indicator automatically transits to a status representing the last utilization information and, when the portable storage device is powered off, remains in the status without requiring power.

### DESCRIPTION OF THE DRAWINGS

The invention can be more fully understood by reading the subsequent detailed description and examples with references made to the accompanying drawings, wherein:

FIG. 1 is a block diagram of a first embodiment of a computer system;

FIG. 2 is a schematic view of a first embodiment of a portable storage device;

FIG. 3 is a flowchart of exemplary operation of the portable storage device;

FIG. 4 is a block diagram of an exemplary driving unit;

FIG. 5 is a block diagram of another exemplary driving unit;

FIG. 6 is a block diagram of a second embodiment of the computer system; and

FIG. 7 is a flowchart of exemplary operation of the second embodiment of the portable storage device.

### DETAILED DESCRIPTION

The portable storage devices with utilization information indicators are provided.

### First Embodiment

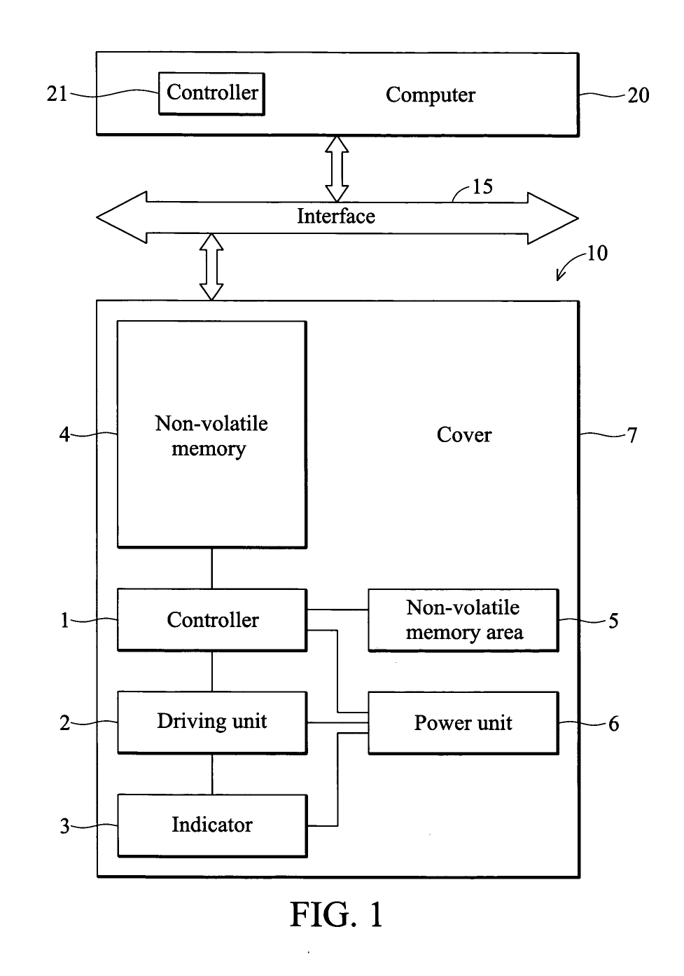

In FIG. 1, computer 20 is connected to portable storage device 10 through interface 15. Computer 20 may comprise a personal computer, a notebook, a limited resource computing device, a communication device, and another electronic device capable of connecting and accessing portable storage device 10. Limited resource computing devices comprise Personal Digital Assistants (PDAs), digital cameras, and portable music players, and video game consoles. Controller 21 is located in computer 20.

Portable storage device 10 may be a hard disk, a flash memory, or other storage device. Controller 1 manages non-volatile memory 4, through which computer 20 accesses non-volatile memory 4.

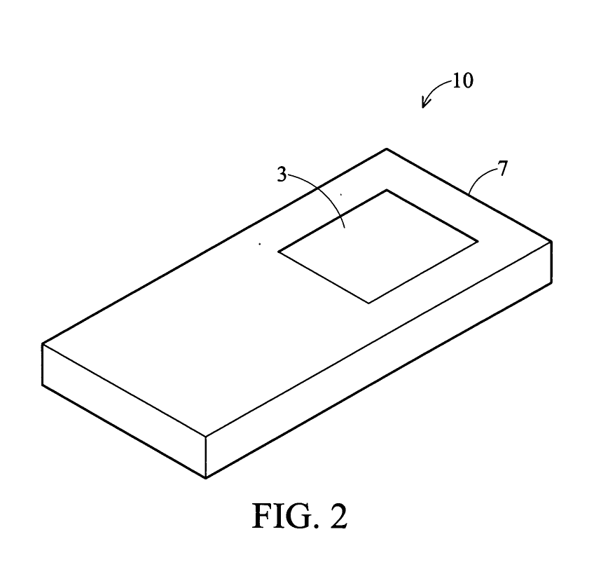

Portable storage device 10 comprises cover 7. Controller 1 is coupled to driving unit 2, indicator 3, non-volatile memory 4, non-volatile memory area 5, and power unit 6. Non-volatile memory 4 may be a flash memory for storing machine-readable data. Indicator 3 displays utilization information of non-volatile memory 4 and may be located on the surface of cover 7, as shown in FIG. 2. Note that indicator 3 may be located elsewhere on the surface of cover 7. Utilization information of non-volatile memory 4 is described later. Driving unit 2 activates indicator 3. Non-volatile memory area 5 stores utilization information of non-volatile memory 4. Power unit 6 provides power to controller 1, driving unit 2, and indicator 3 to display utilization information of non-volatile memory 4.

Portable storage device 10 can be provided with power by computer 20 and performs the following operations when connected thereto.

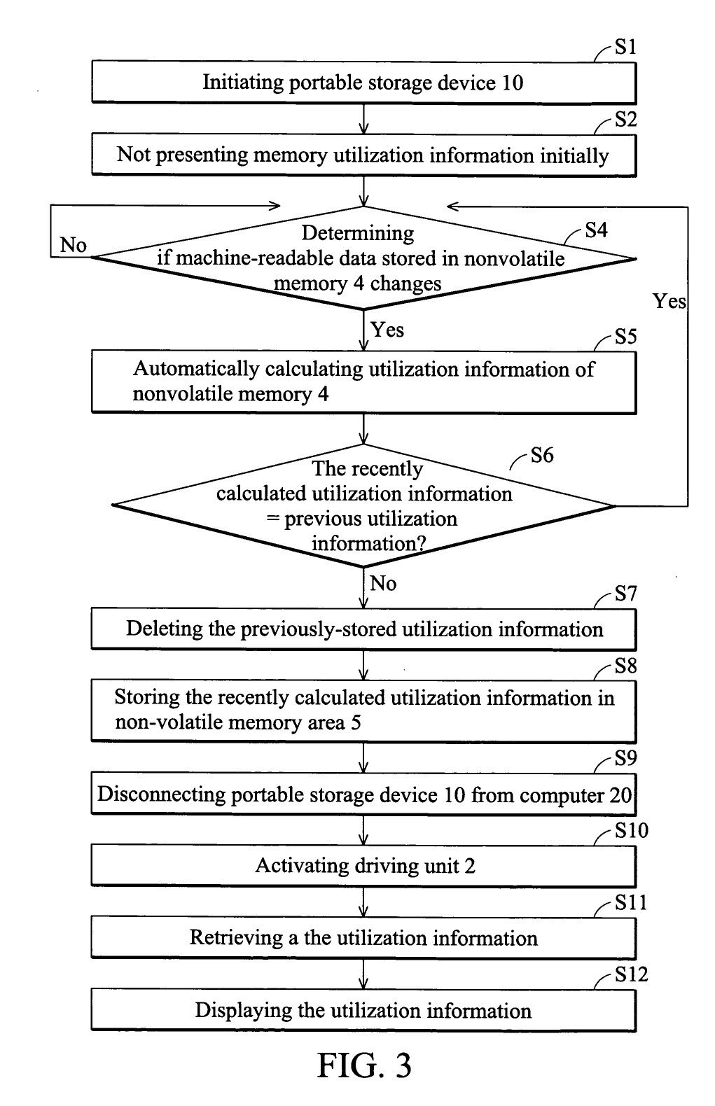

With reference to FIG. 3, portable storage device 10 is initiated (step S1), wherein non-volatile memory area 5 is initiated and receives initial memory utilization information. Non-volatile memory area 5 can be a portion of non-volatile memory 4. For example, controller 1 can calculate the initial utilization information of non-volatile memory 4 by reading all memory elements thereof or utilizing File Allocation Table (FAT) and file chains. Indicator 3 does not present memory utilization information initially (step S2). Controller 1 determines if machine-readable data stored in nonvolatile memory 4 is requested to change (step S4). When amending machine-readable data stored in nonvolatile memory 4, controller 1 automatically calculates utilization information of nonvolatile memory 4 (step S5) and compares it with utilization information (such as the initial utilization information) stored previously in non-volatile memory area 5 (step S6). If these two utilization information records are the same, controller 1 returns to step S4. If these two utilization information records are different, controller 1 deletes the previously-stored utilization information (step S7) and stores the recently calculated utilization information in non-volatile memory area 5 (step S8). Thus, each time the data stored in nonvolatile memory 4 changes, utilization information thereof is automatically stored in nonvolatile memory area 5.

While portable storage device 10 is disconnected from computer 20 (step S9), controller 1 does not access non-volatile memory 4. When driving unit 2 is activated (step S10), indicator 3 retrieves and displays the utilization information stored in non-volatile memory area 5 accordingly (steps S11 and S12).

Power unit 6 provides power to driving unit 2 and indicator 3 to present the utilization information. Power unit 6 may be of small size and low capacitance, limiting the utilization information display time to a predetermined duration. For example, power unit 6 comprising at least a capacitor provides power for only one presentation of the utilization information.

The utilization information can comprise used space and free space of non-volatile memory 4, and/or a ratio of the used space to free space, presented in digital or analog format, such as numbers, graphics, line length, target position, or others.

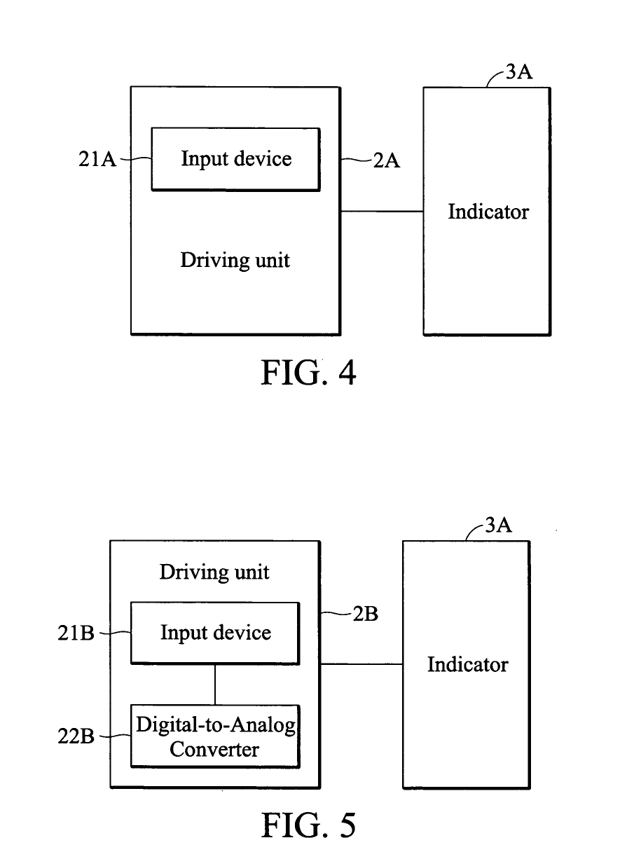

In an example, indicator 3 displays the utilization information in a digital format. As shown in FIG. 4, driving unit 2A and indicator 3A are examples of driving unit 2 and indicator 3, wherein driving unit 2A comprises input device 21A. Indicator 3A may be a digital display, such as a liquid crystal display (LCD). When input device 21A is activated, power unit 6 provides power to indicator 3A to display the utilization information stored in non-volatile memory area 5.

In another example, indicator 3 displays the utilization information in an analog format. As shown in FIG. 5, driving unit 2B and indicator 3A are other examples of driving unit 2 and indicator 3, wherein driving unit 2B comprises input device 21B and Digital-to-Analog Converter (DAC) 22B transforming the utilization information from digital signals to analog signals. Indicator 3A may be an analog indicator, such as a thermometer (such as a thermometer with an alcohol column) reflecting heat generated by the analog signals. When input device 21B is activated, power unit 6 provides power for the following operations. Indicator 3A displays the utilization information stored in non-volatile memory area 5. DAC 22B transforms the utilization information from digital signals to analog signals and transmits the analog signals to indicator 3B to subsequently present a status corresponding to the utilization information. For example, DAC 22B adjusts the voltage drop and the current across a resistor according to the utilization information. DAC 22B generates more heat by adjusting current according to a greater utilization information value. Thus, the thermometer indicates a higher temperature. Conversely, the thermometer indicates a lower temperature according to a lower utilization information value.

Controller 1 can calculate utilization information of non-volatile memory 4 by reading all memory elements thereof or utilizing File Allocation Table (FAT) and file chains. Alternatively, when data is added to or deleted from non-volatile memory 4, controller 1 can calculate bits of added or deleted data and calculate memory utilization information based on the bits and pre-stored utilization information.

### Second Embodiment

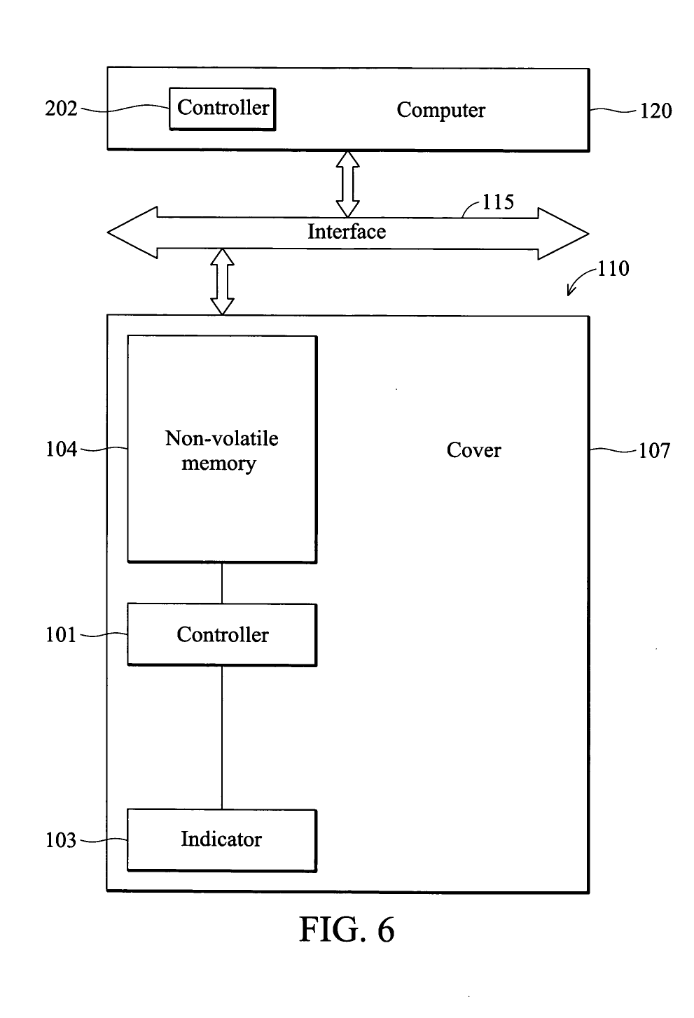

In FIG. 6, computer 120 is connected to portable storage device 110 through interface 115. Computer 120 comprises controller 120. Portable storage device 110 comprises cover 107, controller 101, indicator 103, and non-volatile memory 104.

Controller 101 manages non-volatile memory 104, through which computer 120 accesses non-volatile memory 104.

Indicator 103 may be located on the surface of cover 107. Non-volatile memory 104 may be a flash memory or other memory for storing machine-readable data. Controller 101 is coupled to indicator 103 and non-volatile memory 104. Portable storage device 110 has no power unit. Portable storage device 110, however, can be provided with power by computer 120 to calculate memory utilization information when connected thereto.

Portable storage device 110 can be provided with power by computer 120 to perform the following operations when connected thereto.

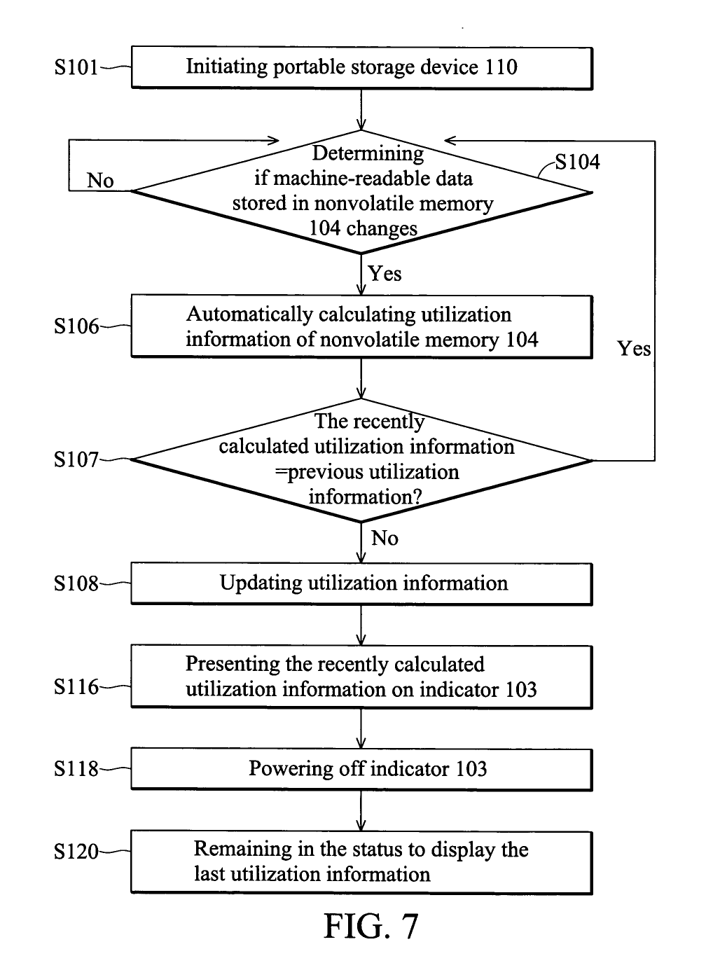

With reference to FIG. 7, portable storage device 110 is initiated (step S101), wherein initial utilization information of non-volatile memory 104 is calculated and stored therein. Note that the initial utilization information can be stored in other memories. Controller 101 determines if machine-readable data stored in nonvolatile memory 104 is requested to change (step S104).

When amending machine-readable data stored in nonvolatile memory 104, controller 101 automatically calculates utilization information of nonvolatile memory 104 (step S106) and compares it with utilization information stored previously in non-volatile memory 104 (step S107). If these two records of utilization information are the same, controller 101 returns to step S104. If these two records of utilization information are different, controller 101 updates utilization information of nonvolatile memory 104 (step S108) and displays the recently calculated utilization information on indicator 103 (step S116). Hence, each time the utilization information of nonvolatile memory 104 changes, indicator 103 automatically displays utilization information of nonvolatile memory 104. Note that utilization information of nonvolatile memory 104 can be computed by another controller, such as controller 202. Alternatively, each time the data stored in nonvolatile memory 104 changes, indicator 103 automatically displays utilization information of nonvolatile memory 104 without comparison to pre-stored utilization information.

For example, memory 104 comprises last utilization information thereof while portable storage device 110 is powered on, and indicator 103 automatically transits to a status representing the last utilization information. When powered off (for example, portable storage device 110 is disconnected from computer 120) (step S118), indicator 103 remains in the status to display the last utilization information without requiring power (step S120).

For example, indicator 103 is a bistable display, such as an E-paper, E-Ink display, or an organic bistable light-emitting diode (OBLED) display. Each time data stored in nonvolatile memory 104 changes, the bistable display automatically transits to a status representing the utilization information of nonvolatile memory 104. When powered off, the bistable display remains in that status to indicate the last utilization information of nonvolatile memory 104.

For example, indicator 103 is a ratchet. Each time data stored in nonvolatile memory 104 changes, the ratchet automatically turns to a position representing the utilization information of nonvolatile memory 104. When powered off, the ratchet remains in that position to indicate the last utilization information of nonvolatile memory 104.

The memory utilization information which can be the used space and free space of non-volatile memory 104, and/or a ratio of the used space and free space and can be presented in numbers, graphics, line length, target position, or others.

Note that features in different embodiments can be combined, amended, or removed to form another embodiment.

Thus, when data stored in a nonvolatile memory of a portable storage device changes, a controller can automatically calculate utilization information of the memory without being instructed by an OS, store it in nonvolatile memory area, and/or display it on an indicator.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable storage device, comprising:
a non-volatile memory storing machine-readable data;
a non-volatile memory area;
a controller coupled to the memory and the memory area, when data stored therein changes, automatically calculating utilization information of the memory and storing the utilization information in the memory area; and
an indicator coupled to the controller, the memory, and the memory area, displaying the utilization information stored in the memory area.

2. The device as claimed in claim 1, further comprising a power unit providing power for displaying the utilization information.

3. The device as claimed in claim 2, wherein the power unit comprises at least a capacitor.

4. The device as claimed in claim 1, further comprising a digital-to-analog converter transforming the utilization information to analog signals to be displayed by the indicator.

5. The device as claimed in claim 4, wherein the indicator comprises a thermometer reflecting heat caused by the analog signals.

6. The device as claimed in claim 1, wherein the memory comprises a flash memory.

7. The device as claimed in claim 1, wherein the indicator automatically displays new utilization information of the memory after each data amendment of the memory.

8. The device as claimed in claim 7, wherein the memory area receives a last utilization information of the memory while the portable storage device is provided with power, the indicator automatically transits to a status representing the last utilization information and, when the portable storage device is powered off, remains in the status without requiring power.

9. The device as claimed in claim 1, wherein the memory area is a portion of the memory.

10. A portable storage device, comprising:
a non-volatile memory storing machine-readable data;
a controller coupled to the memory, automatically calculating utilization information of the memory when data stored therein changes; and
an indicator coupled to the memory and the controller, automatically displaying the utilization information, wherein the controller calculates a last utilization information of the memory while the portable storage device is provided with power, the indicator automatically transits to a status representing the last utilization information and, when the portable storage device is powered off, remains in the status without requiring power.

11. The device as claimed in claim 10, wherein the memory comprises a flash memory.

12. The device as claimed in claim 10, wherein the indicator comprises a ratchet.

13. The device as claimed in claim 10, wherein the indicator comprises a bistable display.

14. The device as claimed in claim 13, wherein the indicator comprises an E-paper or an E-Ink display.

15. The device as claimed in claim 13, wherein the indicator comprises an organic bistable light-emitting diode (OBLED) display.
